(19) United States
(12) Patent Application Publication
(10) Pub. No.: US 2025/0061747 A1
(43) Pub. Date: Feb. 20, 2025

(54) INFORMATION PROCESSING SYSTEM, BEHAVIOR QUANTIFICATION PROGRAM, AND BEHAVIOR QUANTIFICATION METHOD

(71) Applicant: KONICA MINOLTA, INC., Chiyoda-ku, Tokyo (JP)

(72) Inventor: Masashi SONOYAMA, Tokyo (JP)

(73) Assignee: KONICA MINOLTA, INC., Chiyoda-ku, Tokyo (JP)

(21) Appl. No.: 18/722,377

(22) PCT Filed: Nov. 4, 2022
(86) PCT No.: PCT/JP2022/041183

§ 371 Date: Jun. 20, 2024

(30) Foreign Application Priority Data
Dec. 23, 2021 (JP) 2021-209302

(51) Int. Cl. G06V 40/20; G06Q 10/0639; G06V 10/56; G06V 10/70; G06V 40/10

(52) U.S. Cl. CPC G06V 40/23; G06Q 10/06398; G06V 10/56; G06V 10/70; G06V 40/10

(57) ABSTRACT

An information processing system includes a hardware processor that acquires joint points of an object from an image of the object, and quantifies a behavior of the object based on the joint points.

### TECHNICAL FIELD

The present invention relates to an information processing system, a behavior quantification program, and a behavior quantification method.

### BACKGROUND ART

In recent years, productivity has been improved and production costs have been suppressed by automation using robots at manufacturing sites such as factories.

However, particularly in a field such as manufacturing of precision equipment such as an MFP (multifunction peripheral), a precise task which is difficult for a robot is required. In such a field, a manual task is performed, and improvement in productivity and suppression of production costs are required by increasing the efficiency of a task of a worker.

Generally, in order to promote improvement in productivity and the like, methods of quality control and production engineering are utilized. In a method of production engineering, an optimal method is derived by finely quantifying a process, a method for a task, time required for the task, and the like using a scientific method, thereby achieving improvement in productivity and the like. In the method of production engineering, a time analysis method is used to improve a production process. The time analysis method determines a “standard time” from the contents of a task in a process, compares the “standard time” with an “actual work time” obtained by measuring a time actually required for the task in the process with a stopwatch or the like, and specifies and improves a process in which the “actual work time” is significantly longer than the “standard time” as a process with low productivity.

In order to promote the improvement of the process, it is ideal to rotate an improvement cycle of “current state analysis”, “factor identification”, “countermeasure review/introduction”, and “effect measurement” at a high speed based on the time analysis method. In order to perform the “current state analysis” and the “effect measurement”, it is necessary to collect the “actual work time” for all processes. However, in order to collect the “actual work time” for all the processes, a large number of man-hours are usually required, which is a bottleneck of the improvement cycle.

Further, after the “current state analysis” is completed, “task content analysis” for the “factor identification” is performed. Based on the collected actual work time, a direct task (e.g., a task necessary for product assembly) and an indirect task (e.g., a task incidental to the direct task (e.g., discarding garbage, taking a part out of a bag)) are separated, and it is verified which of the direct task or the indirect task takes more time than a specified time, thereby performing the “factor identification”. Currently, these verifications are performed by direct observation of the tasks of a worker in a target process by a person in charge of analysis, which is also a bottleneck of the improvement cycle.

In relation to the time analysis method, the following technology is disclosed in the following Patent Literature 1. When reading of an RFID tag of a worker by an RFID reader is detected, a task instruction screen is displayed. After completion of a task based on the task instruction screen by the worker, when an operation on a task completion button or the like by the worker is detected, the time from the detection of the reading of the RFID tag by the RFID reader to the detection of the operation on the task completion button or the like is calculated and stored as the time required for the task.

### CITATION LIST

### Patent Literature

Patent Literature 1: JP-2019-109856 A

### SUMMARY OF INVENTION

### Technical Problem

However, the technology disclosed in Patent Literature 1 has a problem in that it is necessary for a worker to perform an operation on a device in order to obtain the actual work time, and there is a possibility that the accuracy of the obtained actual work time decreases due to an operation error or the like. The present invention has been made to solve such a problem, and an object of the present invention is to provide an information processing system, a behavior quantification program, and a behavior quantification method that are capable of easily and highly accurately quantifying a behavior of a worker.

### Solution to Problem

The above-described object of the present invention is achieved by the following means.
(1) An information processing system including: an acquirer that acquires joint points of an object from an image of the object; and a behavior quantifier that quantifies a behavior of the object based on the joint points.
(2) The information processing system according to (1), further including an identifying section that identifies the object based on the joint points.
(3) The information processing system according to (2), wherein the identifying section identifies the object based on the joint points and the image from which the joint points have been acquired.
(4) The information processing system according to (2) or (3), further including a controller that associates a quantified value of the behavior of the object quantified by the behavior quantifier with the object identified by the identifying section.
(5) The information processing system according to (3), further including: a specifying section that specifies a joint point to which a predetermined article is attached among the joint points; and a color information extractor that extracts, from the image, color information of the joint point specified by the specifying section as the color information of the object, wherein the identifying section identifies the object based on the extracted color information.
(6) The information processing system according to (5), wherein the specifying section specifies the joint point designated by a user as the joint point to which the predetermined article is attached.
(7) The information processing system according to (5) or (6), wherein the identifying section identifies the object corresponding to the joint point from which the color information having a luminance value within a predetermined range has been extracted among the extracted color information.
(8) The information processing system according to any one of (1) to (7), further including a trajectory calculator that calculates a trajectory of the joint points, wherein the behavior quantifier quantifies the behavior of the object by calculating a moving distance of the object based on the trajectory.
(9) The information processing system according to any one of (1) to (8), further including: a feature amount calculator that calculates a feature amount based on the joint points; and a determinator that determines a task performed by the object in the image as a plurality of types of tasks based on the joint points and the feature amount, wherein the behavior quantifier quantifies the behavior of the object for each of the determined tasks.
(10) The information processing system according to (9), wherein the feature amount includes a relative distance between the joint points.
(11) The information processing system according to (9) or (10), wherein the feature amount includes a movement speed of the joint points.
(12) The information processing system according to any one of (9) to (11), wherein the determinator determines the task performed by the object as the plurality of types of tasks by supervised learning in which a task flag of each of the tasks is set as an objective variable and the joint points and the feature amount are set as explanatory variables.
(13) The information processing system according to any one of (9) to (11), wherein the determinator determines the task performed by the object as the plurality of types of tasks by unsupervised learning based on a distribution of the joint points acquired from a plurality of time-series frames of the image.
(14) A behavior quantification program for causing a computer to execute: (a) acquiring joint points of an object from an image of the object; and (b) quantifying a behavior of the object based on the joint points.
(15) A behavior quantification method including: (a) acquiring joint points of an object from an image of the object; and (b) quantifying a behavior of the object based on the joint points.

### Advantageous Effects of Invention

Joint points of an object are acquired from an image of the object, and a behavior of the object is quantified based on the joint points. Thus, it is possible to simply and highly accurately quantify a behavior of a worker.

### BRIEF DESCRIPTION OF DRAWINGS

FIG. 1 is a diagram illustrating a schematic configuration of an information processing system.

FIG. 2 is a block diagram illustrating a hardware configuration of an information processing apparatus.

FIG. 3 is a block diagram illustrating functions of a controller of the information processing apparatus.

FIG. 4 is an explanatory diagram illustrating an example of joint points.

FIG. 5 is a diagram illustrating joint points together with a captured image.

FIG. 6 is a diagram illustrating the contents of an analysis result integration file.

FIG. 7 is a diagram illustrating a trajectory of a worker in a captured image.

FIG. 8 is a diagram illustrating a total moving distance of a worker with respect to time.

FIG. 9 is a flowchart illustrating an operation of the information processing apparatus.

FIG. 10 is a block diagram illustrating functions of a controller of an information processing apparatus.

FIG. 11 is a diagram illustrating joint points together with a captured image.

FIG. 12 is a diagram illustrating the contents of an analysis result integration file.

FIG. 13 is a flowchart illustrating an operation of the information processing apparatus.

### DESCRIPTION OF EMBODIMENTS

Hereinafter, an information processing system, a behavior quantification program, and a behavior quantification method according to each embodiment of the present invention will be described with reference to the drawings. Note that in the drawings, the same components are denoted by the same reference signs, and redundant description is omitted. In addition, dimensional ratios in the drawings are exaggerated for convenience of description and may be different from actual ratios.

### First Embodiment

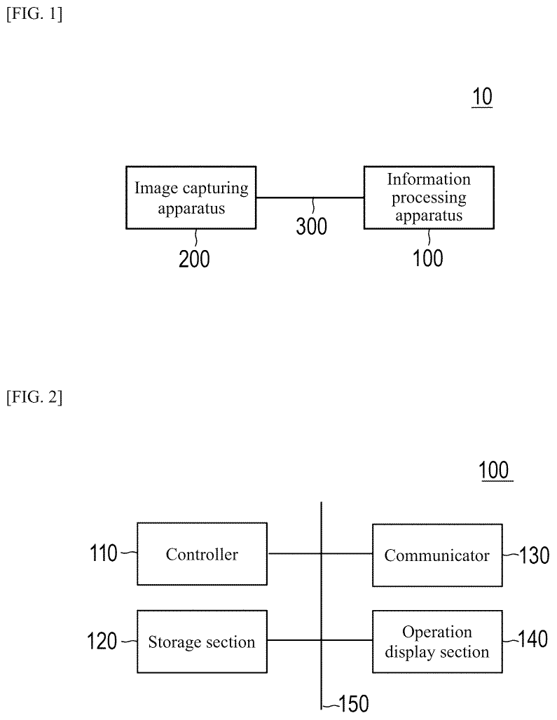

FIG. 1 is a diagram illustrating a schematic configuration of an information processing system 10.

The information processing system 10 includes an information processing apparatus 100, an image capturing apparatus 200, and a communication network 300. The information processing apparatus 100 is communicably connected to the image capturing apparatus 200 by the communication network 300. Note that the information processing system 10 may include only the information processing apparatus 100. The image capturing apparatus 200 constitutes an image acquirer.

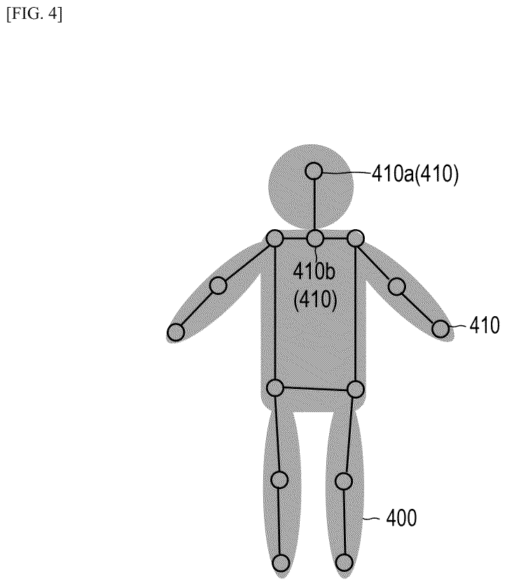

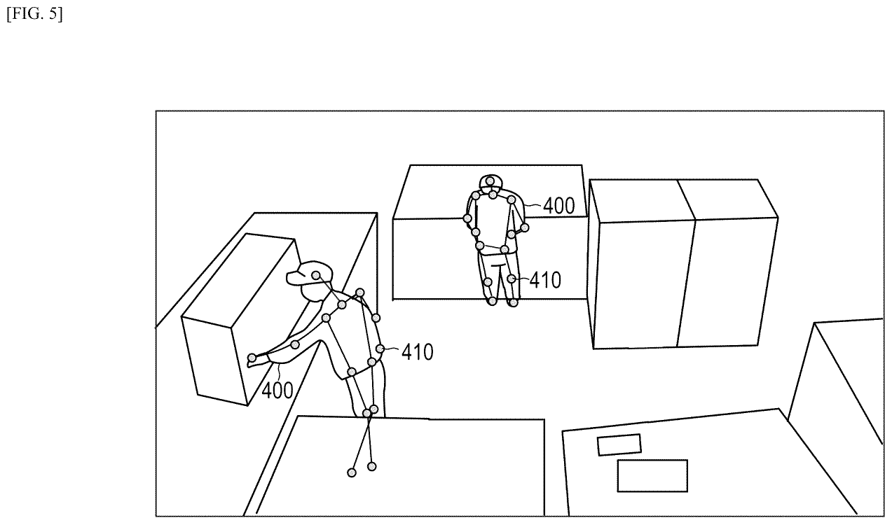

The information processing apparatus 100 detects (estimates) joint points 410 (see FIG. 4) of an object included in a captured image received from the image capturing apparatus 200, and quantifies a behavior of the object based on the joint points 410. The object may be an articulated object, such as a person. Hereinafter, in order to simplify the description, it is assumed that the object is a worker 400 (see FIG. 5) who is a person.

The image capturing apparatus 200 includes, for example, a near-infrared camera, is installed at a predetermined position, and captures an image of an imaging region from the predetermined position. The image capturing apparatus 200 may capture an image of the imaging region by irradiating the imaging region with near-infrared light by a light emitting device (LED) and receiving, by a complementary metal oxide semiconductor (CMOS) sensor, reflected light of the near-infrared light reflected off the object in the imaging region. The captured image may be a monochrome image in which each pixel represents the reflectance of the near-infrared light. The predetermined position may be, for example, a ceiling of a manufacturing factory where the worker 400 works as a worker. The imaging region may be, for example, a three-dimensional region including the entire floor of the manufacturing factory. The image capturing apparatus 200 may capture an image of the imaging region as a moving image including a plurality of captured images (frames) at a frame rate ranging from 15 fps to 30 fps, for example.

As the communication network 300, a network interface compliant with a wired communication standard such as Ethernet (R) may be used. As the communication network 300, a network interface compliant with wireless communication standards Bluetooth (R) and IEEE802.11 may be used.

FIG. 2 is a block diagram illustrating a hardware configuration of the information processing apparatus 100. The information processing apparatus 100 includes a controller 110, a storage section 120, a communicator 130, and an operation display section 140. Those constituent elements are connected to each other via a bus 150. The information processing apparatus 100 may include a computer.

The controller 110 includes a central processing unit (CPU), and controls various components of the information processing apparatus 100 and performs arithmetic processing according to a program. Details of functions of the controller 110 will be described later.

The storage section 120 may include a random access memory (RAM), a read only memory (ROM), and a flash memory. The RAM, as a workspace of the controller 110, temporarily stores therein programs and data. The ROM stores therein various kinds of programs or various pieces of data in advance. The flash memory stores therein various kinds of programs including an operation system and various pieces of data.

The communicator 130 is an interface for communicating with an external device. For communication, a network interface compliant with a standard such as Ethernet (R), SATA, PCI Express, USB, or IEEE1394 may be used. In addition, for communication, a wireless communication interface compliant with Bluetooth (R), IEEE802.11, and 4G may be used. The communicator 130 receives the captured image from the image capturing apparatus 200. The operation display section 140 includes, for example, a liquid crystal display, a touch screen, and various keys. The operation display section 140 receives various kinds of operation and input, and displays various kinds of information.

Functions of the controller 110 will be described.

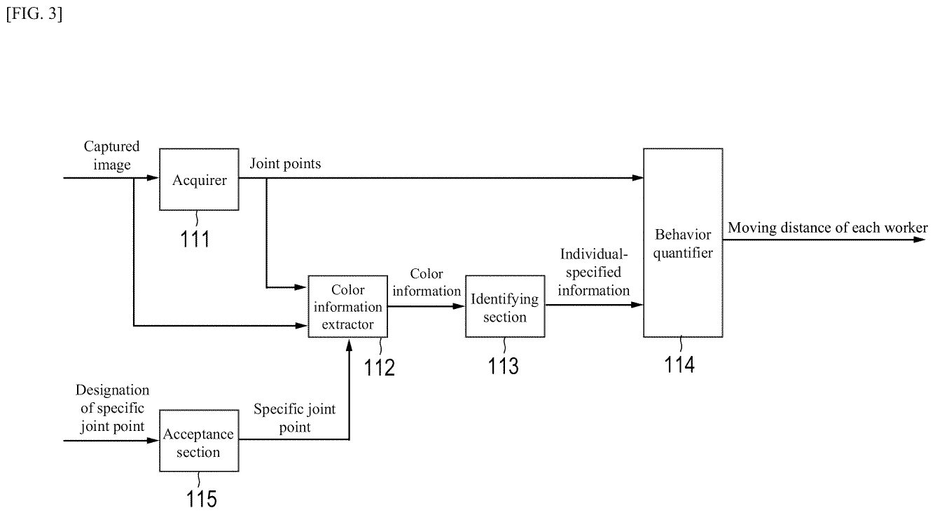

FIG. 3 is a block diagram illustrating functions of the controller 110 of the information processing apparatus 100. The controller 110 functions as an acquirer 111, a color information extractor 112, an identifying section 113, a behavior quantifier 114, and an acceptance section 115 by executing a program. The color information extractor 112 and the identifying section 113 constitute an identifying section by combining their functions. The acceptance section 115 forms a specifying section. The behavior quantifier 114 constitutes a trajectory calculator. The acquirer 111, the color information extractor 112, and the identifying section 113 execute processing on each frame of the captured image.

The acquirer 111 acquires the joint points 410 by detecting the joint points 410 of the worker 400 from the captured image. Specifically, the acquirer 111 detects the joint points 410 as, for example, coordinates of pixels in the captured image. In a case where a plurality of workers 400 are included in the captured image, the acquirer 111 may detect joint points 410 for each of the workers 400.

The acquirer 111 detects the joint points 410 of each worker 400 by estimating the joint points 410 from the captured image using machine learning. The acquirer 111 may detect the joint points 410, for example, as follows. A human rectangle including the worker 400 is detected from the captured image by using a trained model of a neural network trained for estimating the human rectangle from the captured image. Then, the joint points 410 are detected from the human rectangle using the trained model of the neural network trained for estimating the joint points 410 from the human rectangle. An example of a trained model for estimating the human rectangle from the captured image is a region proposal network (RPN) model. As trained models for detecting the joint points 410 from the human rectangle, for example, there are models of Deep Pose, Convolution Neural Network (CNN), and Res Net. The joint points 410 may include, for example, the head, nose, neck, shoulders, elbows, wrists, hips, knees, ankles, eyes, and ears. The following description will be given taking as an example a case where the joint points 410 detected by the acquirer 111 are the joint points 410 of the head, neck, shoulders, elbows, wrists, hips, knees, and ankles.

By using the above-described trained model, the acquirer 111 may calculate, for each pixel of the captured image, the likelihood of each class of the joint points 410 of the worker 400 (classification of the joint points 410 such as the left shoulder, the right shoulder, and the left hip), and detect, as each joint point 410, a pixel having a likelihood equal to or higher than a predetermined threshold. Therefore, a pixel having a likelihood lower than the predetermined threshold is not detected as a joint point 410. For example, when the likelihood of a pixel decreases to less than the predetermined threshold due to the degree of clarity of an image of the worker 400 in the captured image, the effect of occlusion, or the like, the joint point 410 is not detected. Thus, erroneous detection of the joint points 410 is suppressed.

FIG. 4 is an explanatory diagram illustrating an example of the joint points 410. Note that the joint points 410 are indicated by white circles in FIG. 4. Furthermore, to simplify the description, an image of the worker 400 is also illustrated with a silhouette.

As illustrated in FIG. 4, the joint points 410 may include a joint point 410a of the head and a joint point 410b of the neck.

FIG. 5 is a diagram illustrating joint points 410 together with a captured image.

In an example illustrated in FIG. 5, two workers 400 are working in a standing state, and the joint points 410 of the workers 400 are detected.

The color information extractor 112 extracts color information of a joint point 410 (hereinafter, referred to as a “specific joint point”) specified by the acceptance section 115 from the captured image as color information of the worker 400. Specifically, the color information extractor 112 extracts, from the captured image, the color information of the coordinates of the specific joint point among the joint points 410 detected by the acquirer 111. In a case where images of a plurality of workers 400 are included in the captured image, the color information extractor 112 extracts color information of a specific joint point for each of joint points 410 of each of the workers 400. In a case where the number of workers 400 included in the captured image is one, the color information extractor 112 may not extract the color information of the specific joint point. This is because, in this case, only the specific worker 400 is included in the captured image, and thus it is considered that a target for quantifying a behavior of the worker 400, which will be described later, has been specified from the start.

The specific joint point may be a joint point 410 to which a predetermined article worn by the worker 400 is attached. The predetermined article may be an article including information capable of specifying each worker 400. The information that can specify each worker 400 includes a color. The article includes, for example, a cap, a bib, pants, an arm band, and a breast band. Note that, as in a modification example described later, the article may be an IC tag, a chameleon code, or the like. Hereinafter, in order to simplify the description, the description will be made assuming that the information capable of specifying each worker 400 is a color and the article including the information is a hat. That is, it is assumed that each worker 400 is wearing a hat having a unique color for specifying the worker 400.

In a case where images of a plurality of workers 400 are included in the captured image, when a behavior of only a worker among the workers 400 is quantified, an article of a color in which a luminance value extracted as color information by the color information extractor 112 is within a predetermined range may be worn by only the worker 400 among the workers 400. Next, an object corresponding to a joint point 410 from which color information having a luminance value within the predetermined range has been extracted among the color information extracted by the color information extractor 112 may be identified, and a behavior of only the joint point 410 of the identified object may be quantified based on the joint point 410. The identifying section 113 identifies the worker 400 based on the color information extracted by the color information extractor 112. Specifically, the identifying section 113 refers to, for example, a table that is set by a user and stored in advance in the storage section 120 and that defines a correspondence relationship between color information and a worker ID that is information for specifying the worker 400. The identifying section 113 then detects the worker ID associated with the color information that matches the extracted color information to identify the worker 400.

The acceptance section 115 may specify, as the specific joint point designated by the user, the specific joint point input to the operation display section 140 by the user. For example, as described above, in a case where each worker 400 wears a hat (an example of an attached article) having a unique color for specifying the worker 400, the specific joint point may be the joint point 410 of the head.

Note that the specific joint point may be set in advance by being stored in the storage section 120 or the like, and in this case, the function of the acceptance section 115 may be omitted.

Furthermore, the specific joint point may be substituted with a point other than the joint points 410. For example, the specific joint point may be substituted with a midpoint between two joint points 410 (e.g., the joint point 410 of the right shoulder and the joint point 410 of the left hip).

The joint points 410 of each worker 400 detected for each frame from the captured image and a specified worker ID may be associated and stored in the storage section 120 as an analysis result integration file.

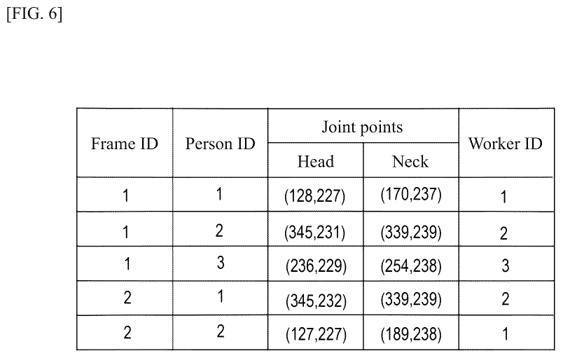

FIG. 6 is a diagram illustrating the contents of the analysis result integration file. In the analysis result integration file, a frame ID, a person ID, joint points 410, and a worker ID are associated with each other. A frame ID may be a unique number that is assigned to each frame of the captured image to specify the frame. A person ID is a unique number that is assigned to each person (worker 400) detected as a human rectangle or the like to specify the person. Note that the person ID is the number given to distinguish the person for each frame, and is not a number by which the worker 400 can be individually specified. The individual worker 400 can be identified (specified) by a worker ID.

In an example illustrated in FIG. 6, in order to simplify the description, only the head and the neck are illustrated as the joint points 410, and the other detected joint points 410 are omitted. The joint point 410a of the head may be designated as the specific joint point as described above. The joint point 410b of the neck may be used for quantification of a behavior of the worker 400, which will be described later.

After being specified by the identifying section 113, the worker ID for identifying the worker 400 may be added to the analysis result integration file in association with the joint points 410 or the like.

The behavior quantifier 114 quantifies a behavior of each worker 400 based on the joint points 410. Specifically, for example, the behavior quantifier 114 reads the analysis result integration file, and converts a change (movement) of the joint point 410 of the neck of each worker 400 between frames consecutive in time series into an actual moving distance. Then, the sum of movement distances for frames within a predetermined time is calculated as a moving distance of each worker 400 within the predetermined time. This corresponds to calculating a trajectory of the joint points 410 for each worker 400 and calculating the moving distance of each worker 400 based on the calculated trajectory. Thus, the behavior of each worker 400 may be quantified. Note that in the conversion of the change of the joint point 410 of the neck between chronologically consecutive frames into the moving distance, a conversion formula for converting the coordinates of the joint point 410b of the neck before and after the change into the moving distance may be created based on known distance information in the captured image and used.

The behavior quantifier 114 may associate a quantified value such as the moving distance obtained by quantifying a behavior of each worker 400 with the worker ID identified by the identifying section 113, and output the moving distance of each worker 400. The output includes display on the display of the operation display section 140, transmission to another apparatus by the communicator 130, and the like.

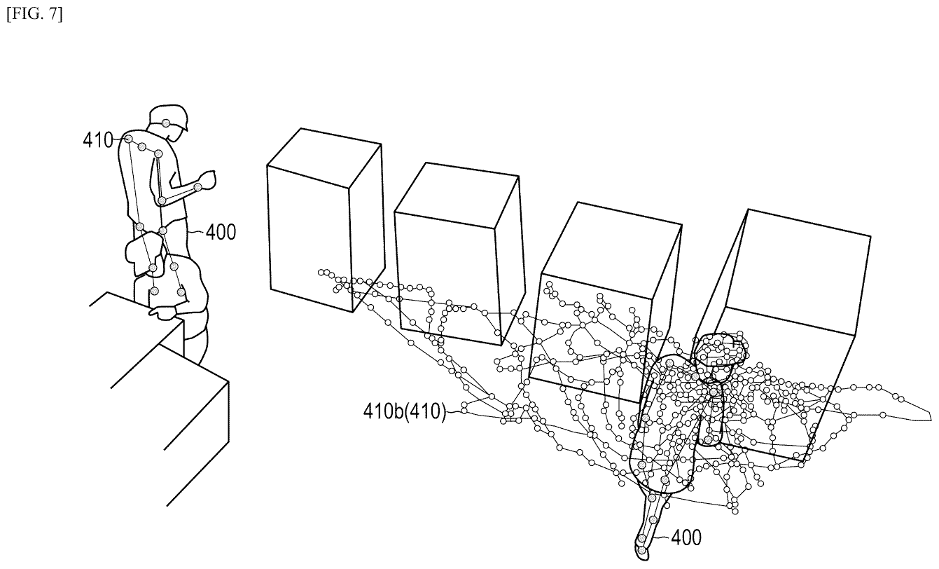

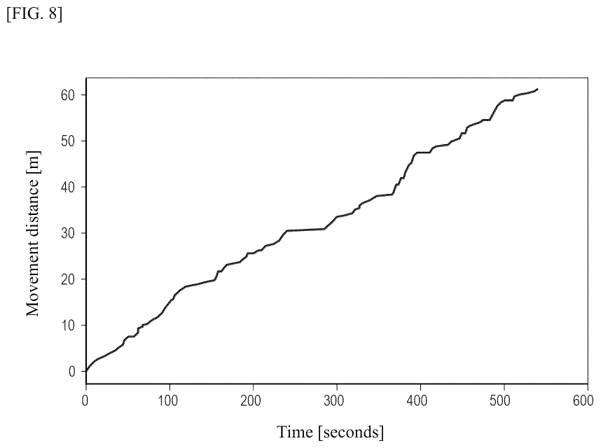

FIG. 7 is a diagram illustrating a trajectory of the worker 400 in a captured image. FIG. 8 is a diagram illustrating a total moving distance of the worker 400 with respect to time. To simplify the description, FIG. 7 illustrates the trajectory of the worker 400 superimposed on the captured image.

In an example illustrated in FIG. 7, the joint point 410b of the neck detected in each frame of the captured image for 10 minutes is superimposed.

It is considered that the worker 400 having a shorter total moving distance in a predetermined time period is working with more efficient movement. For each worker 400, the total moving distance in a predetermined time is calculated to quantify a behavior, so that a task is improved according to the individual worker 400, and thus the productivity of an entire manufacturing process is improved.

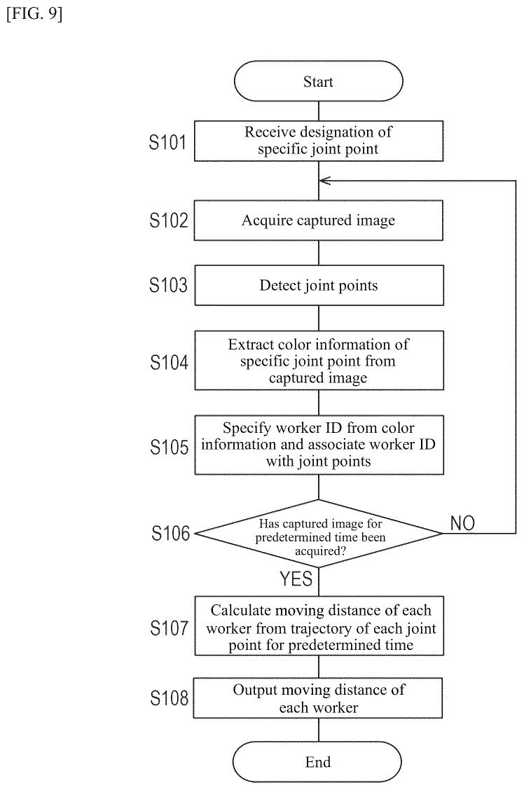

FIG. 9 is a flowchart illustrating an operation of the information processing apparatus 100. This flowchart may be performed by the controller 110 of the information processing apparatus 100 in accordance with a program. Steps S102 to S105 may be performed for each frame of a captured image.

The controller 110 receives the designation of a specific joint point from the user and specifies the specific joint point (S101).

The controller 110 acquires the captured image by receiving it from the image capturing apparatus 200 (S102).

The controller 110 detects the joint points 410 of each worker 400 from the captured image (S103).

The controller 110 extracts color information of the specific joint point from the captured image (S104).

The controller 110 specifies the worker ID from the extracted color information to thereby specify the individual worker 400 and associates the worker ID with the joint points 410 of the worker 400 (S105).

The controller 110 determines whether the captured image for a predetermined time has been acquired (S106). The predetermined time may be set to any time. The predetermined time may be, for example, 10 minutes. When determining that the captured image for the predetermined time has been acquired (S106: YES), the controller 110 performs step S107. When determining that the captured image for the predetermined time has not been acquired (S106: NO), the controller 110 continues the acquisition of the captured image until the captured image for the predetermined time is acquired (S102).

The controller 110 calculates a moving distance of each worker 400 from a trajectory of the joint points 410 for the predetermined time (S107).

The controller 110 outputs the moving distance of each worker 400 in association with each worker 400 (S108).

### Second Embodiment

A second embodiment will be described. The present embodiment is different from the first embodiment in the following points. In the first embodiment, the moving distance of each worker 400 is calculated to quantify a behavior of the worker 400. On the other hand, in the present embodiment, a behavior of each worker 400 is quantified by calculating a work time for each task of each worker. In other respects, the present embodiment is similar to the first embodiment, and therefore, redundant description is omitted.

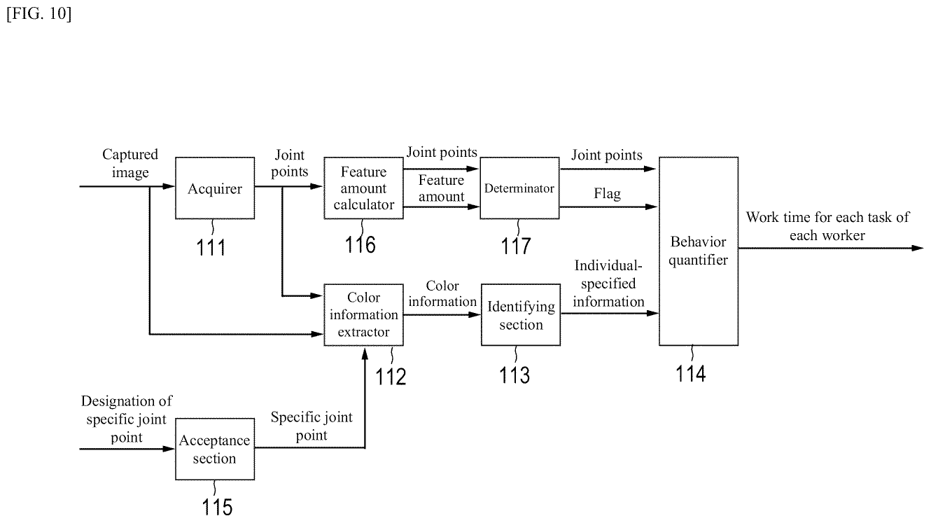

FIG. 10 is a block diagram illustrating functions of a controller 110 of an information processing apparatus 100. The controller 110 functions as an acquirer 111, a color information extractor 112, an identifying section 113, a behavior quantifier 114, a feature amount calculator 116, a determinator 117, and an acceptance section 115 by executing a program.

The feature amount calculator 116 calculates a feature amount based on the joint points 410 acquired by the acquirer 111. The feature amount is a value that may contribute to the determination of a task and may be an arbitrary value that can be calculated from the joint points 410. The feature amount includes, for example, a relative distance between the joint points 410 and the movement speed of each joint point 410. The relative distance between the joint points 410 is, for example, the distance between the joint point 410 of an elbow and the joint point 410 of a wrist, and may be calculated from the joint points 410 (more specifically, the coordinates of the joint points 410). The movement speed of each joint point 410 is, for example, the movement speed of the joint point 410b of the neck, and may be calculated from the moving distance of the joint point 410b of the neck between frames of a captured image and the frame rate.

The determinator 117 determines a task performed by the worker 400 in the captured image as a plurality of types of tasks based on the joint points 410 and the feature amount. For example, the determinator 117 determines a task performed by the worker 400 in the captured image as one of a direct task and an indirect task. The direct task is essential for product assembly and the like. The direct task may include a task having a high degree of contribution to product assembly or the like. The indirect task is a task incidental to the direct work, and includes, for example, a task of discarding waste, taking a part out of a bag, and the like.

The determinator 117 may determine a task performed by the worker 400 as a plurality of types of tasks by associating a task flag capable of specifying the task with the joint points 410 or the like. The task flag may be, for example, a flag that assigns “1” to a direct task and assigns “0” to an indirect task.

The determinator 117 may be configured using a trained model that has undergone machine learning by supervised learning. The trained model may be a model of a neural network on which supervised learning has been performed using the task flag of each task as an objective variable and using the joint points 410 and the feature amount calculated by the feature amount calculator 116 as explanatory variables. As the teacher data, a combination of the captured image and a correct answer label annotated with a flag indicating a direct task as “1” and an indirect task as “0” by visually determining a task of the worker 400 in the captured image may be used.

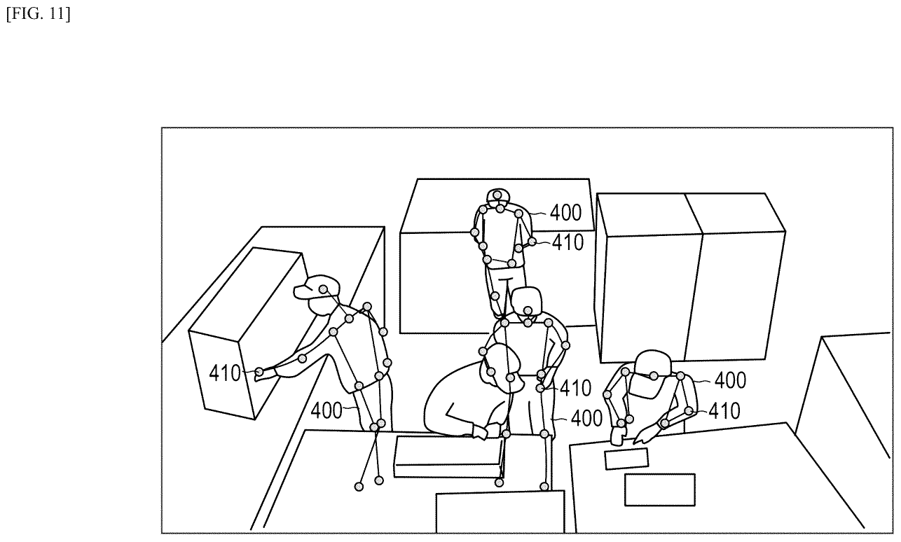

FIG. 11 is a diagram illustrating joint points 410 together with a captured image.

In an example illustrated in FIG. 11, a worker 400 who is performing a precise assembly task on a desk while sitting on a chair and a worker who is performing a task while standing are present. The determinator 117 can also determine, with high accuracy, a task with few motions, such as a task performed on a desk, as a plurality of types of tasks by using the joint points 410 and the feature amount.

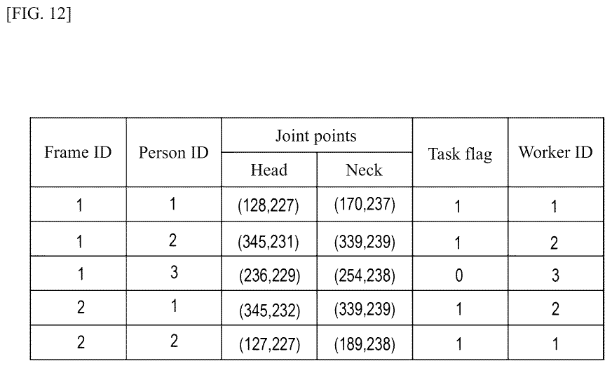

FIG. 12 is a diagram illustrating the contents of an analysis result integration file. In the analysis result integration file, a frame ID, a person ID, a joint point 410, a task flag, and a worker ID are associated with each other.

The task flag for specifying a task of the worker 400 may be added to the analysis result integration file in association with the joint points 410 or the like after being determined by the determinator 117.

The worker ID may be specified by the identifying section 113 based on color information of a specific joint point, and then added to the analysis result integration file in association with the joint points 410 or the like.

The determinator 117 may determine a task performed by the worker 400 in the captured image as a plurality of types of tasks by unsupervised learning based on a distribution of the joint points 410 acquired from each of a plurality of time-series frames of the captured image. For example, when a distribution of a joint point 410 of a wrist of the worker 400 who is performing a precise assembly task on a desk while sitting on a chair is obtained and the joint point 410 that significantly varies (e.g., a variation of 30 or more) from the average of the joint points 410 (average coordinates) is detected, it may be determined that the task is abnormal. The determinator 117 may determine the task by clustering based on the distribution of the joint points 410. For example, for each of a plurality of tasks, a distribution of the joint point 410 (e.g., the joint point 410 of the wrist) of each worker 400 is acquired in advance, whereby a distribution range of the joint points 410 is defined for each task. Then, the task may be determined depending on which distribution range the joint point 410 belongs to. In addition, the task may be determined not only by looking at the distribution of the joint point 410 in one place but also by combining distributions of the plurality of joint points 410.

The behavior quantifier 114 quantifies a behavior of each worker 400 by calculating, for each worker 400, a work time for each task based on the analysis result integration file. The behavior quantifier 114 may output the work time for each task that is a quantified value obtained by quantifying a behavior of each worker 400 in association with a worker ID identified by the identifying section 113.

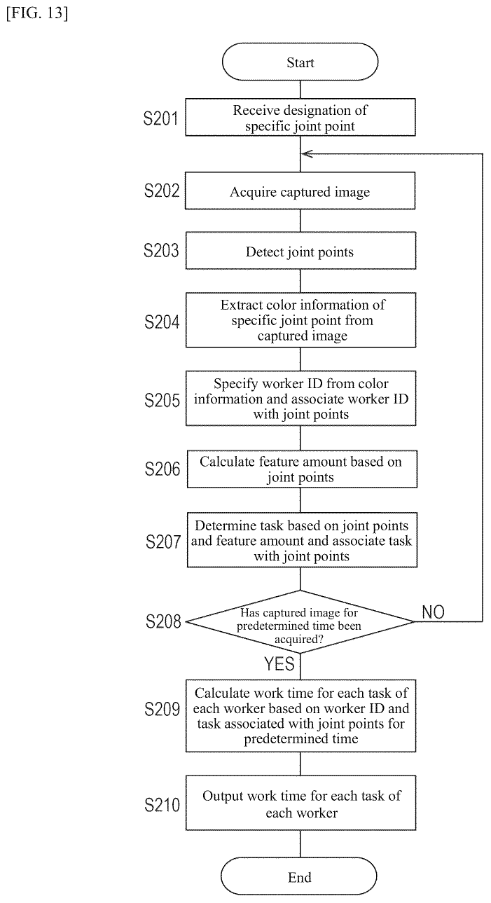

FIG. 13 is a flowchart illustrating an operation of the information processing apparatus 100. This flowchart may be performed by the controller 110 of the information processing apparatus 100 in accordance with a program. Steps S102 to S105 may be performed for each frame of a captured image.

The controller 110 receives the designation of the specific joint point from the user and specifies the specific joint point (S201).

The controller 110 acquires the captured image by receiving it from the image capturing apparatus 200 (S202).

The controller 110 detects the joint points 410 of each of the workers 400 from the captured image (S203).

The controller 110 extracts color information of the specific joint point from the captured image (S204).

The controller 110 specifies a worker ID from the extracted color information to thereby specify each individual worker 400 and associates the worker ID with the joint points 410 of each worker 400 (S205).

The controller 110 calculates a feature amount based on the joint points 410 (S206).

The controller 110 determines a task based on the joint points 410 and the feature amount, and associates the determined task with the joint points 410 (S207).

The controller 110 determines whether the captured image for a predetermined time has been acquired (S208). The predetermined time may be set to any time. The predetermined time may be, for example, 10 minutes. When determining that the captured image for the predetermined time has been acquired (S208: YES), the controller 110 executes step S209. When determining that the captured image for the predetermined time has not been acquired (S208: NO), the controller 110 continues the acquisition of the captured image until the captured image for the predetermined time is acquired (S202).

The controller 110 calculates a work time for each task of each worker 400 based on the worker ID and the task associated with the joint points 410 for the predetermined time (S209).

The controller 110 outputs the work time for each task of each worker 400 in association with each worker 400 (S210).

### Modification Examples

In the above-described embodiments, the examples have been described in which a predetermined article worn by each worker 400 is an article to which a color capable of specifying each worker 400 is applied. However, the predetermined article may be an IC tag, a chameleon code, or the like. In this case, the identifying section 113 acquires, from the IC tag, position information and the worker ID of the worker 400 having the IC tag, converts the position information and the worker ID into the coordinates of the pixels in the captured image, and specifies the individual worker 400 present at the converted coordinates by the worker ID. The correspondence relationship between the position information of the worker 400 and the coordinates of the pixels in the captured image is acquired in advance by measurement or the like and stored in the storage section 120, and by using this, the position information of the worker 400 can be converted into the coordinates of the pixels in the captured image. In a case where the predetermined article is a chameleon code, since an image of the chameleon code is included in the captured image, the image of the chameleon code can be used to specify the individual worker 400.

The identifying section 113 may specify the individual worker 400 in the captured image using a known face authentication technique. In this case, it is not necessary for the predetermined article to be worn by the worker 400.

The embodiments produce the following effects.

Joint points of an object are acquired from an image of the object, and a behavior of the object is quantified based on the joint points. Thus, it is possible to simply and highly accurately quantify a behavior of a worker.

Furthermore, the object is identified based on the joint points. Thus, a behavior of each worker can be easily quantified with high accuracy.

Furthermore, the object is identified based on the joint points and the image from which the joint points were acquired. Thus, the object to be quantified can be specified more easily.

Furthermore, a quantified value of the behavior of the object that is quantified is associated with the identified object. Thus, the object whose behavior has been quantified can be easily grasped.

Furthermore, a joint point to which a predetermined article is attached is specified, and color information of the specified joint point is extracted from the image as color information of the object. Then, the object is identified based on the extracted color information. Thus, the object whose behavior is quantified can be identified with high sensitivity and high accuracy regardless of the angle of view of the image and the orientation of the object appearing in the image.

Furthermore, the joint point designated by the user is specified as a joint point to which a predetermined article is attached. In this way, it is possible to more flexibly and easily set the position at which the article for specifying the object is attached.

Furthermore, among the extracted color information, an object corresponding to a joint point from which color information having a luminance value within the predetermined range has been extracted is identified. Thus, when an article whose luminance value is within the predetermined range in the captured image is worn by the object, it is possible to easily set a target whose behavior is to be quantified.

Furthermore, the behavior of the object is quantified by calculating a trajectory of the joint points and calculating the moving distance of the object based on the trajectory. Thus, a task of the worker can be improved from the viewpoint of the moving distance. In addition, specifying a timing when the amount of movement increases and a behavior of the worker when the amount of movement increases can effectively improve the task of the worker.

Further, a feature amount is calculated based on the joint points, and the task performed by the object in the image is determined as a plurality of types of tasks based on the joint points and the feature amount. Then, the behavior of the object is quantified for each determined task. Accordingly, for example, even in a case where the joint points do not move and the relative positional relationship between the joint points changes, such as a case where a relatively fine manual task such as tightening a screw is performed, it is possible to improve the accuracy of determining the task. In addition, even if a person in charge of task improvement at a manufacturing site is not fixed at a task site, it is possible to easily acquire the work time for each task and to early determine, based on the work time for each task, whether or not a countermeasure is required. In addition, for example, since it is possible to detect a timing at which the number of indirect tasks is relatively large and provide a moving image at the timing to the person in charge of task improvement, it is possible to lead to improvement of the task of the worker at an early stage.

Furthermore, the feature amount includes a relative distance between the joint points. Accordingly, it is possible to improve the accuracy of determining the task based on the image.

Furthermore, the feature amount includes a movement speed of the joint point. Accordingly, it is possible to improve the accuracy of determining the task based on the image.

Further, the task performed by the object is determined as a plurality of types of tasks by supervised learning in which the task flag of each task is set as an objective variable and the joint points and the feature amount are set as explanatory variables. Thus, the task can be easily and highly accurately determined based on the image.

Further, based on a distribution of the joint points acquired from the plurality of time-series frames of the image, the task performed by the object is determined as a plurality of types of tasks by unsupervised learning. Thus, the task can be easily and highly accurately determined based on the image.

The present invention is not limited to the above-described embodiments.

For example, some steps of the flowcharts may be omitted. Furthermore, any two or more of the steps may be executed in parallel in order to, for example, reduce the processing time.

Furthermore, a part or all of the processing performed by the programs in the embodiments may be performed in the form of hardware such as circuits.

The present application is based on Japanese Patent Application (Japanese Patent Application No. 2021-209302) filed on Dec. 23, 2021, the disclosure content of which is incorporated by reference in its entirety.

### REFERENCE SIGNS LIST

10 information processing system
100 information processing apparatus
110 controller
111 acquirer
112 color information extractor
113 identifying section
114 behavior quantifier
115 acceptance section
116 feature amount calculator
117 determinator
120 storage section
130 communicator
140 operation display section
200 image capturing apparatus
300 communication network
400 worker
410 joint point
410a joint point of the head
410b joint point of the neck

1. An information processing system comprising:
a hardware processor that
acquires joint points of an object from an image of the object, and
quantifies a behavior of the object based on the joint points.

2. The information processing system according to claim 1, wherein the hardware processor further identifies the object based on the joint points.

3. The information processing system according to claim 2, wherein the hardware processor identifies the object based on the joint points and the image from which the joint points have been acquired.

4. The information processing system according to claim 2, wherein the hardware processor further associates a quantified value of the behavior of the object with the identified object.

5. The information processing system according to claim 3, wherein the hardware processor further:
specifies a joint point to which a predetermined article is attached among the joint points, and
extracts, from the image, color information of the specified joint point as the color information of the object,
wherein the hardware processor identifies the object based on the extracted color information.

6. The information processing system according to claim 5, wherein the hardware processor specifies a joint point designated by a user as the joint point to which the predetermined article is attached.

7. The information processing system according to claim 5, wherein the hardware processor identifies the object corresponding to the joint point from which the color information having a luminance value within a predetermined range has been extracted among the extracted color information.

8. The information processing system according to claim 1, wherein the hardware processor further calculates a trajectory of the joint points, wherein the hardware processor quantifies the behavior of the object by calculating a moving distance of the object based on the trajectory.

9. The information processing system according to claim 1, wherein the hardware processor further:
calculates a feature amount based on the joint points, and
determines a task performed by the object in the image as a plurality of types of tasks based on the joint points and the feature amount,
wherein the hardware processor quantifies the behavior of the object for each of the determined tasks.

10. The information processing system according to claim 9, wherein the feature amount includes a relative distance between the joint points.

11. The information processing system according to claim 9, wherein the feature amount includes a movement speed of the joint points.

12. The information processing system according to claim 9, wherein the hardware processor determines the task performed by the object as the plurality of types of tasks by supervised learning in which a task flag of each of the tasks is set as an objective variable and the joint points and the feature amount are set as explanatory variables.

13. The information processing system according to claim 9, wherein the hardware processor determines the task performed by the object as the plurality of types of tasks by unsupervised learning based on a distribution of the joint points acquired from a plurality of time-series frames of the image.

14. A non-transitory recording medium storing a behavior quantification program for causing a computer to execute operations comprising:
(a) acquiring joint points of an object from an image of the object; and
(b) quantifying a behavior of the object based on the joint points.

15. A behavior quantification method comprising:
(a) acquiring joint points of an object from an image of the object; and
(b) quantifying a behavior of the object based on the joint points.
